(19) United States
(12) Patent Application Publication
(10) Pub. No.: US 2017/0193861 A1
(43) Pub. Date: Jul. 6, 2017

(54) ORNAMENT FOR LEATHER PRODUCT

(71) Applicant: YujinKreves, Ltd., Seoul (KR)

(72) Inventors: Jong-yong Kim, Cheonan-si (KR); Young-yeon Kim, Incheon (KR); Kee-bong Nam, Changwon-si (KR); Myung-soo Kim, Seoul (KR)

(73) Assignee: YujinKreves, Ltd.

(21) Appl. No.: 15/070,217

(22) Filed: Mar. 15, 2016

(30) Foreign Application Priority Data
Dec. 30, 2015 (KR) 10-2015-0189169

(51) Int. Cl. G09F 3/02; G09F 3/04

(52) U.S. Cl. CPC G09F 3/02; G09F 3/04

(57) ABSTRACT

The present disclosure provides an ornament secured to a leather product, the ornament comprising: a fame and a metal sticker attached to the frame, wherein the frame comprises a body, an upwardly-protruding edge from a top face of the body and along an outer perimeter of the body, and a securing portion downwardly extending from a bottom face of the body and securing the body into a leather face portion of the leather product, wherein the body is formed in a predetermined shape, and the protruding edge extends along the shape, wherein the metal sticker is formed in the shape, wherein the protruding edge defines an attachment region on the top face of the body, wherein the metal sticker is attached to the body in the attachment region thereof, wherein the protruding edge has varying shapes to allow, in a combination with a shape of the metal sticker, a variety of designs for the ornament.

### REFERENCE TO RELATED APPLICATIONS

This application claims the priority benefit of Korean Patent Application No. 10-2015-0189169 filed on Dec. 30, 2015, the entire contents of which are incorporated herein by reference.

### FIELD OF THE INVENTION

The present disclosure relate to an ornament secured to a leather face of a leather product, wherein the ornament include a frame with a protruding edge from a top face thereof along an outer perimeter thereof and a metal sticker with a predetermined shape to be attached to the frame, the protruding edge allowing an easy attachment of the metal sticker to the frame, and preventing the attached metal sticker from a damage and/or detachment due to an external force.

### BACKGROUND OF THE INVENTION

Typically, a leather product such as a wallet, purse, handbag, etc. may have an ornament secured thereto, the ornament having a shape corresponding to manufacturer name characters, logo, product name characters or the like. This may allow a consumer to identify the leather product.

This ornament may be manufactured by a variety of approaches, including, for example, attaching a metal sticker with a variety of colors to the leather product, or securing a frame wrapped with a metal foil to the product, or printing a metal foil in a recessed portion in the leather face.

Among the above approaches, the way of employing the metal sticker has been competitive in that the sticker renders a high degree gloss, and an elegant appearance, and allows an anti-counterfeit function. This metal sticker may be limited in a shape and/or size, and, thus, may be applied to a massive production with smaller numbers of product models and a small production with larger numbers of product models.

However, as shown in FIG. 1A and FIG. 1B, when the metal sticker S has been attached to a leather face of the leather product 10, an external force F may be applied to the metal sticker S, such that the sticker S may slide on the leather face, thereby to deform and/or detach the metal stickers.

Furthermore, in a prior art, an ornament is wrapped with a metal foil and then attached to a leather face of the leather product. In this case, a three-dimensional effect may be available. However, during a use thereof, the metal foil may be detached from the ornament. This may lead to a lowered recognition ability of the ornament

Further, in a prior art, the leather face portion of the leather product is recessed and an ornament is formed in the recess. In this case, the ornament may have a prolonged lifespan. However, an aesthetic feel for the ornament may deteriorate, and a recognition ability of the ornament may be lowered.

Further, in a prior art, the leather face portion of the leather product is recessed and a metal foil as an ornament is printed in the recess. In this case, during a use thereof, the metal foil may be detached from the leather face, thus leading to a lowered recognition ability of the ornament.

For example, Korean patent publication number 2013-0005983 titled as “METHOD FOR ATTACHING ORNAMENT TO LEATEHR PRODUCT” discloses the above approach. As shown in FIG. 2. this prior art method includes forming a recess in a leather face portion of a leather product using a molding or laser-cutting process, applying an epoxy fluid adhesive on the recess using a silk-screen printing process, drying the adhesive at 15 to 28° C., attaching an ornament on the dried adhesive, pressure-bonding the ornament using a thermal-fusion process, applying a brightener on an exposed face of the ornament using a spraying or silk-screen printing process, and drying the brightener at 15 to 28° C.

In this prior method, where a metal sticker as the ornament is attached directly on the leather face, the metal sticker may tend to be detached from the leather face due to a gas emitted from the leather material.

In addition, there is a need to provide a variety of designs for the ornament by increasing a shape freedom thereof together with a variety of color selections.

### SUMMARY OF THE INVENTION

The present disclosure provides an ornament for a leather product, where the ornament is constructed such that a metal sticker thereof having a shape of a manufacturer name, logo, or product name character of the product may be easily attached to a frame of the ornament, and may be prevented from a damage and/or a detachment due to an external force. Further, the ornament in accordance with the present disclosure may allow a variety of designs thereof via a combination of shapes and/or colors of the frame and the metal sticker.

In accordance with one aspect of the present disclosure, there is provided an ornament secured to a leather product, the ornament comprising: a fame and a metal sticker attached to the frame, wherein the frame comprises a body, an upwardly-protruding edge from a top face of the body and along an outer perimeter of the body, and a securing portion downwardly extending from a bottom face of the body and securing the body into a leather face portion of the leather product, wherein the body is formed in a predetermined shape associated with the leather product, and the protruding edge extends along the shape, wherein the metal sticker is formed in the shape, wherein the protruding edge defines an attachment region on the top face of the body, wherein the metal sticker is attached to the body in the attachment region thereof, wherein the protruding edge allows an easy attachment of the sticker to the body, and prevents the sticker from a damage and/or a detachment due to an external force, wherein the protruding edge has varying shapes to allow, in a shape-combination with the metal sticker, a variety of designs for the ornament.

In one embodiment, the predetermined shape corresponds to a manufacture name character, logo, and/or a product name character of the leather product.

In one embodiment, the protruding edge varies in a horizontal and/or vertical length, and/or a shape of a corner thereof.

In one embodiment, the edge and/or the sticker has varying colors to allow a variety of designs for the ornament.

In the present discourse, the protruding edge of the frame of the ornament may vary in a shape thereof, thereby leading to a variety of designs of the ornament for the leather product, especially in a combination with a shape of the metal sticker. In addition, this shape variation may be further combined with a variation in colors of the frame and the meal sticker, thereby to a larger variety of designs of the ornament for the leather product.

### BRIEF DESCRIPTION OF THE DRAWINGS

A brief description of each drawing is provided to more fully understand the drawings, which is incorporated in the detailed description of the disclosure.

FIG. 1A and FIG. 1B illustrates a state when a detachment or damage of a meal sticker occurs in a conventional ornament for a leather product.

FIG. 2 illustrates an exploded perspective view for an attachment of a conventional ornament to a leather product.

FIG. 3 illustrates a configuration of an ornament secured to a leather face of a leather product in accordance with one embodiment of the present disclosure.

FIG. 4 illustrates a cross-section view of an ornament secured to a leather face of a leather product in accordance with one embodiment of the present disclosure.

FIGS. 5A and 5B illustrate respective front and perspective views of an appearance of a leather product having an ornament attached thereto in accordance with one embodiment of the present disclosure, where the ornament has a protruding edge having a small thickness.

FIGS. 6A and 6B illustrate respective front and perspective views of an appearance of a leather product having an ornament attached thereto in accordance with one embodiment of the present disclosure, where the ornament has a protruding edge having a larger thickness.

FIG. 7 illustrates a variation of FIG. 3 where an inner side portion of the protruding edge changes, and, accordingly, an outer side portion of the metal sticker changes.

FIG. 8A to FIG. 8C illustrate respective cross-sectional views of variations of FIG. 4 where the edge shape of the ornament varies.

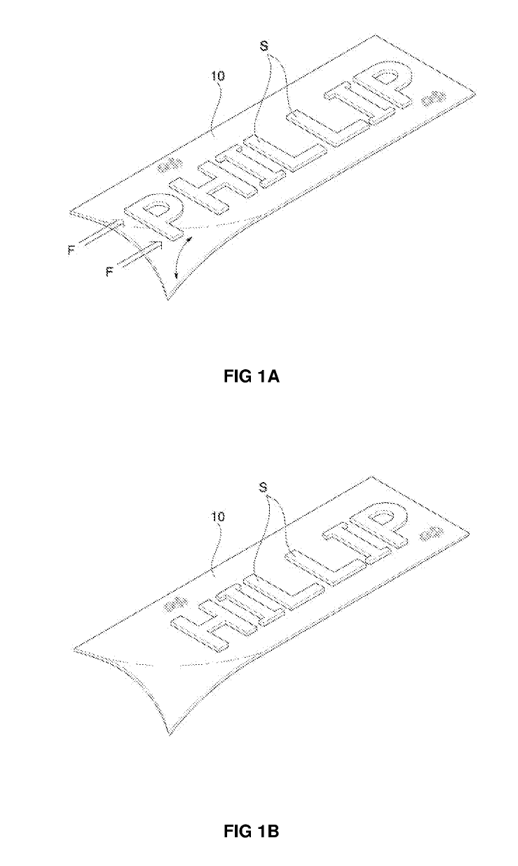

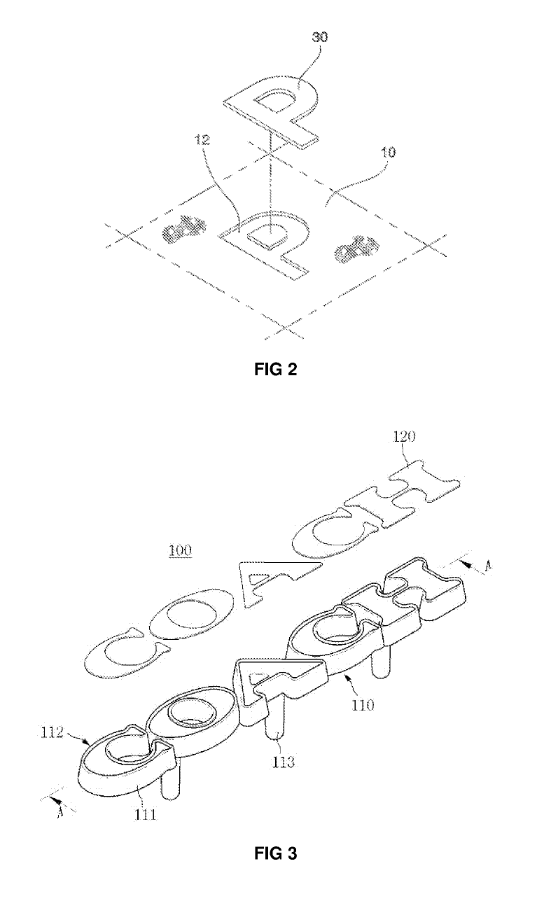

### DETAILED DESCRIPTION OF THE INVENTION

Examples of various embodiments are illustrated in the accompanying drawings and described further below. It will be understood that the discussion herein is not intended to limit the claims to the specific embodiments described. On the contrary, it is intended to cover alternatives, modifications, and equivalents as may be included within the spirit and scope of the present disclosure as defined by the appended claims.

Example embodiments will be described in more detail with reference to the accompanying drawings. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art.

Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “connected to”, or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, s, operations, elements, and/or components, but do not preclude the presence or addition of one or more other features, integers, s, operations, elements, components, and/or groups thereof. As used herein, the term “and/or” includes any and all combinations of one or more of the associated listed items. Expression such as “at least one of” when preceding a list of elements may modify the entire list of elements and may not modify the individual elements of the list.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the following description, numerous specific details are set forth in order to provide a thorough understanding of the present disclosure. The present disclosure may be practiced without some or all of these specific details. In other instances, well-known process structures and/or processes have not been described in detail in order not to unnecessarily obscure the present disclosure.

Hereinafter, the various embodiments of the present disclosure will be described in details with reference to attached drawings, where thicknesses of layers and/or spaces there between may be presented for the sake of convenience of illustration, and, thus, may be exaggerated compared to actual thickness and/or spaces. In the following descriptions, well-known structures to the art may be skipped in order not to obscure the present disclosure. When designating reference numerals for components in the drawings, it may be intended that like reference numbers may refer to like components throughout the drawings.

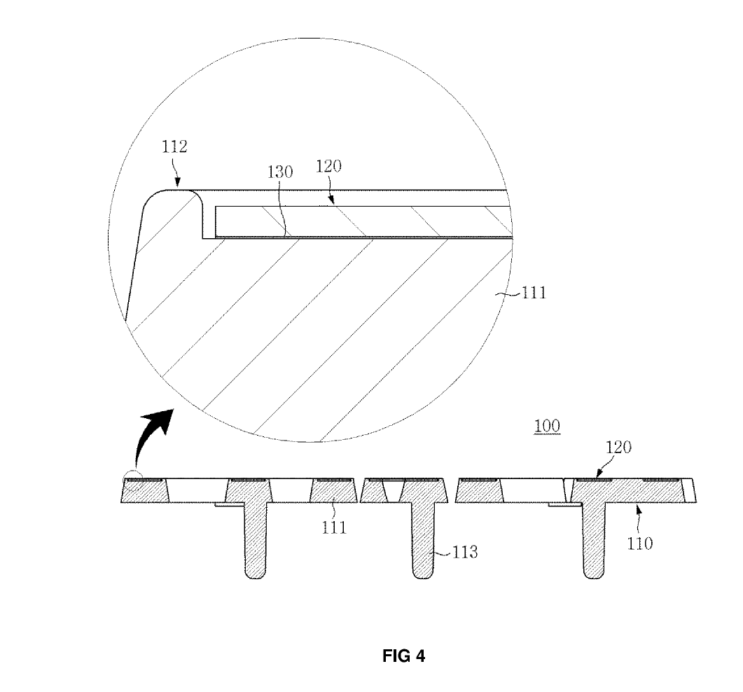

FIG. 3 illustrates a configuration of an ornament secured to a leather face of a leather product in accordance with one embodiment of the present disclosure. FIG. 4 illustrates a cross-section view of an ornament secured to a leather face of a leather product in accordance with one embodiment of the present disclosure.

The ornament 100 secured to a leather face of a leather product in accordance with one embodiment of the present disclosure includes, as shown in FIG. 3 and FIG. 4, a frame 110, a metal sticker 120 bonded to the frame 110, and an adhesive 130 to bond the metal sticker 120 to the frame 110.

The frame 110 may include a body 111, an edge 112, and securing portion 113.

The body 111 may have a predetermined shape. The shape may correspond to manufacturer name characters, logo, and/or product name characters of the leather product. However, the shape is not limited thereto.

The edge 112 may protrude upwardly in an outer perimeter of the body 111 from a top thereof. The protrusion may have a shape corresponding to the shape of the body 111. The protrusion of the edge 112 may define a placement region of the metal sticker 120. That is, the protrusion may surround the placement region. Then, the metal sticker 120 may be attached to the placement region. Due to the protrusion of the edge 112, the sticker 120 may be positioned onto the body 111 more easily. The sticker 120 may be confined within and by the protruding edge, and, thus, be prevented from a damage and/or detachment due to an external force.

The edge 112 may have a variable thickness, that is, a horizontal length. This varying thickness of the edge 112 may be combined to the metal sticker 120, leading to a variety of ornament designs. Further, changes in colors of the edge 112 and/or the metal sticker 129 may be added to the varying thickness of the edge 112, leading to a large variety of ornament designs.

The securing portion 113 may protrude downwardly from a bottom of the body 111, to secure the body 111 of the frame 110 to the leather face portion of the leather product 200.

The frame 110 may have a smooth surface, which is not the case when using a conventional polishing process. In particular, in one embodiment of the present disclosure, the edge 112 may be fabricated in a finer manner using a zinc casting process. Further, the edge 112 may render a variety of colors including a gold, gun metal, Roh, etc. The edge 112 and the metal sticker 120 may have the same or different color.

The metal sticker 120 may have a shape corresponding to the edge 112. In other words, the sticker 120 may have a shape corresponding to manufacturer name characters, logo, and/or product name characters of the leather product. The metal sticker 120 may be made of SUS, trivalent chrome, etc. The metal sticker may render a variety of colors including a gold, gun metal, Roh, etc. The sticker 120 and the frame 110 may have the same or different color. In one embodiment of the present disclosure, the metal sticker 120 may render a color using a plating process with a good workability. The sticker 120 may be placed and bonded in and to a sticker region on the frame 110, which is surrounded with the protruding edge as described above.

The adhesive 130 may act to bond the metal sticker 120 to the frame 110. The adhesive 130 may include, but be not limited to, a liquid adhesive, a double-sided tape, or a thermal-fused tape. In one embodiment of the present disclosure, the metal sticker 120 may be pressure-bonded to the frame 110 via a thermal-fusing process with a good adhering reliability.

In this way, via the adhesive 130, the metal sticker 120 has been pressure-bonded to the frame 110, thereby to form the ornament 100 as shown in FIG. 4. The resultant ornament 100 may be secured to the leather product via the securing portion 113 formed at a bottom of the body 111. This securing may be achieved by the securing portion 113 passing through the leather face portion of the leather product 200 while a free end thereof is deformed.

The ornament 100 as configured above may have a variety of designs, for example, due to the varying thickness of the edge 112 at the outer perimeter of the body 111, as mentioned above.

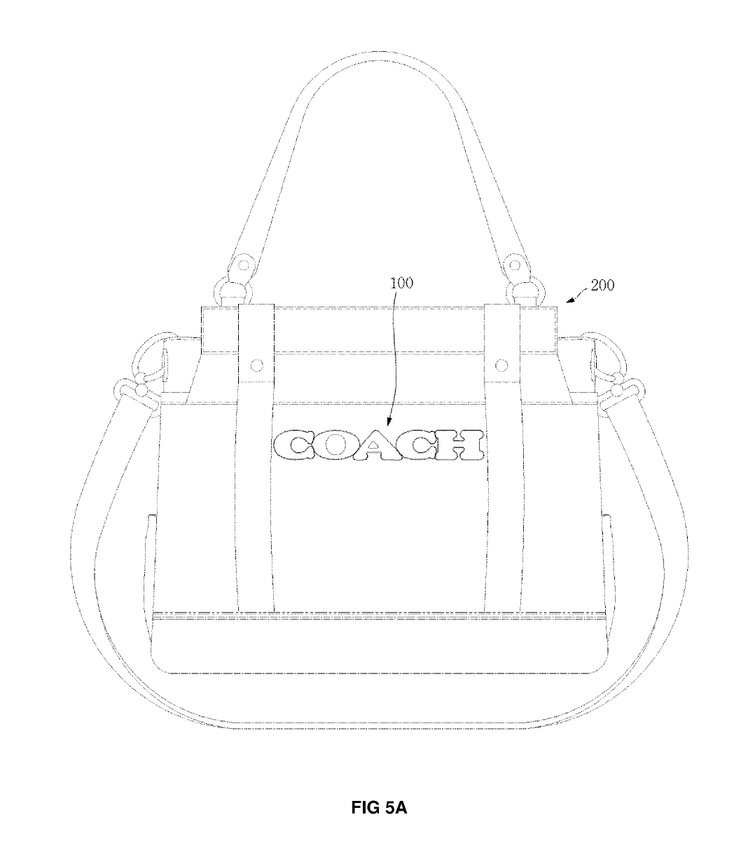

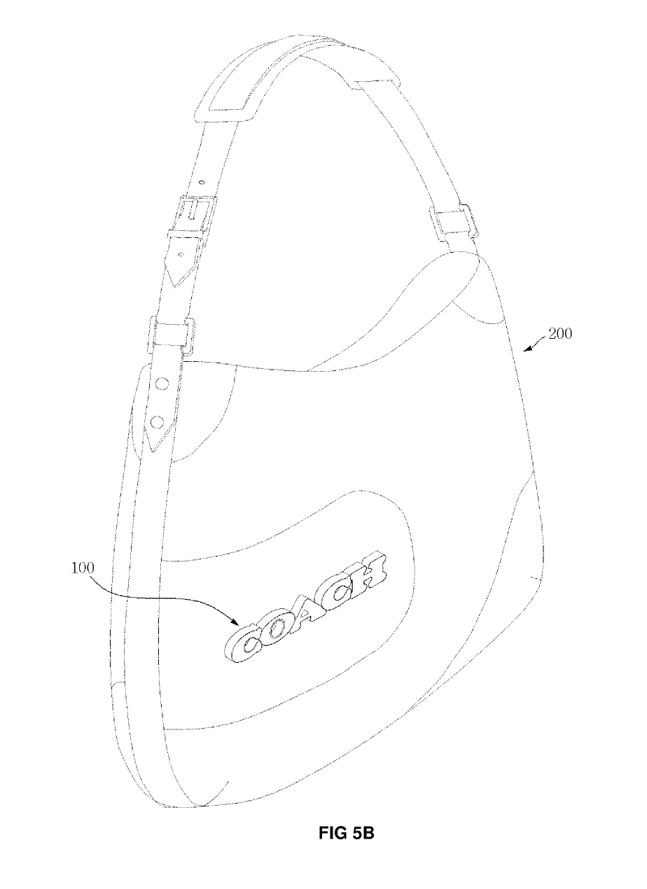

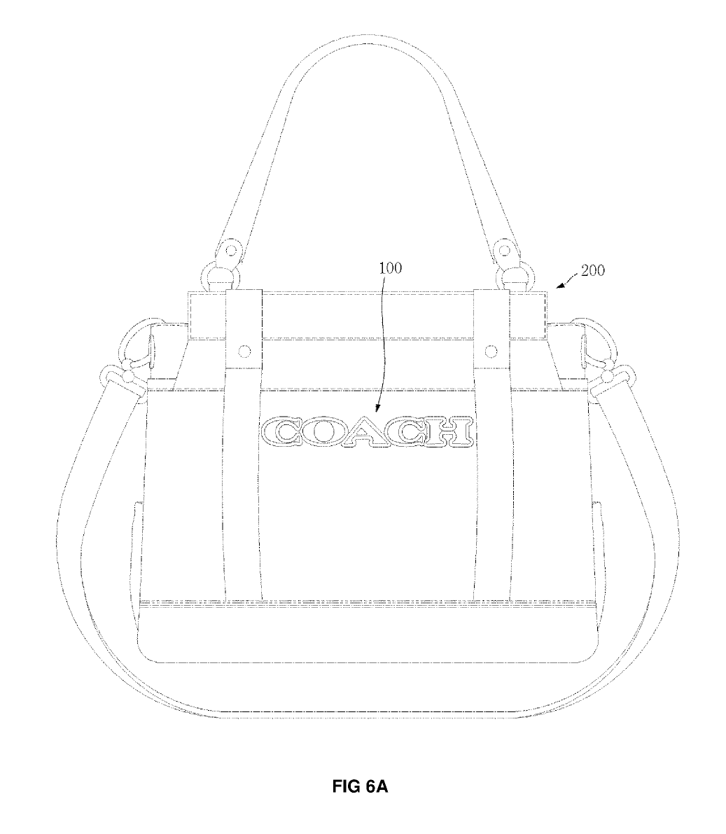

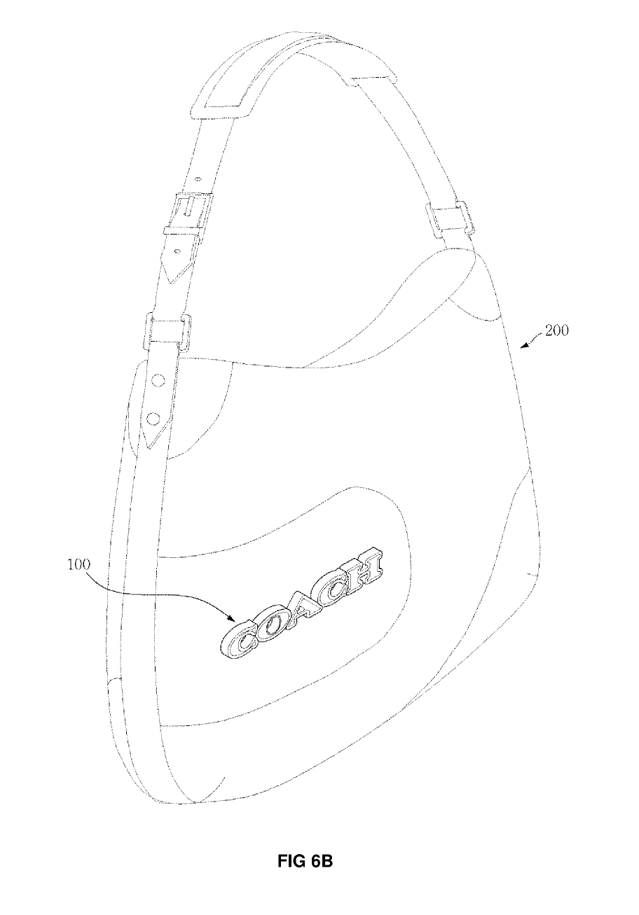

FIGS. 5A and 5B illustrate respective front and perspective views of an appearance of a leather product having an ornament attached thereto in accordance with one embodiment of the present disclosure, where the ornament has a protruding edge having a small thickness, that is, a horizontal length. To the contrary, FIGS. 6A and 6B illustrate respective front and perspective views of an appearance of a leather product having an ornament attached thereto in accordance with one embodiment of the present disclosure, where the ornament has a protruding edge having a larger thickness.

In this manner, the varying thickness of the protrusion of the edge 112 of the frame 110 may lead to a variety of designs of the ornament 100, as shown in FIG. 5A to FIG. 6B.

When it comes to the thickness of the protruding edge 112, the relatively smaller thickness of the protruding edge 112 may result in a larger region surrounded with the edge 112, and, hence, a larger sticker region, which may translate to a larger size of the metal sticker 120. To the contrary, the relatively larger thickness of the protruding edge 112 may result in a smaller region surrounded with the edge 112, and, hence, a smaller sticker region, which may translate to a smaller size of the metal sticker 120. In this fashion, the size of the thickness of the protruding edge 112 may affect an aesthetic feel of the ornament 100.

In one embodiment, the edge 112 may be subjected to a zinc casting process as described above, to have a smooth and uniform surface thereof. Further, this process may further facilitate a thickness adjustment of the edge. For example, the edge may be sized to a range from 0.15 mm to 0.5 mm

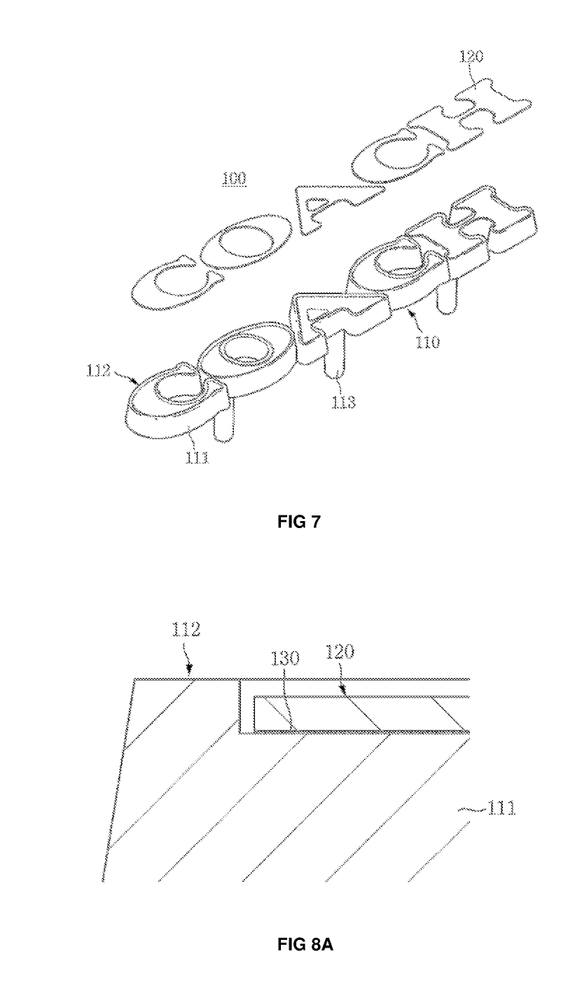

FIG. 7 illustrates a variation of FIG. 3 where an inner side portion of the protruding edge changes, and, accordingly, an outer side portion of the metal sticker changes.

In this variation, the edge 112 may not have a uniform thickness but an un-uniform thickness. In this case, as shown in FIG. 7, the metal sticker 120 may change in a shape thereof to comply with the shape of the edge 112. Thus, the un-uniform thickness of the edge 112 in a combination with the changed shape of the metal sticker 120 may lead to a new aesthetic feel, and, thus, a new design.

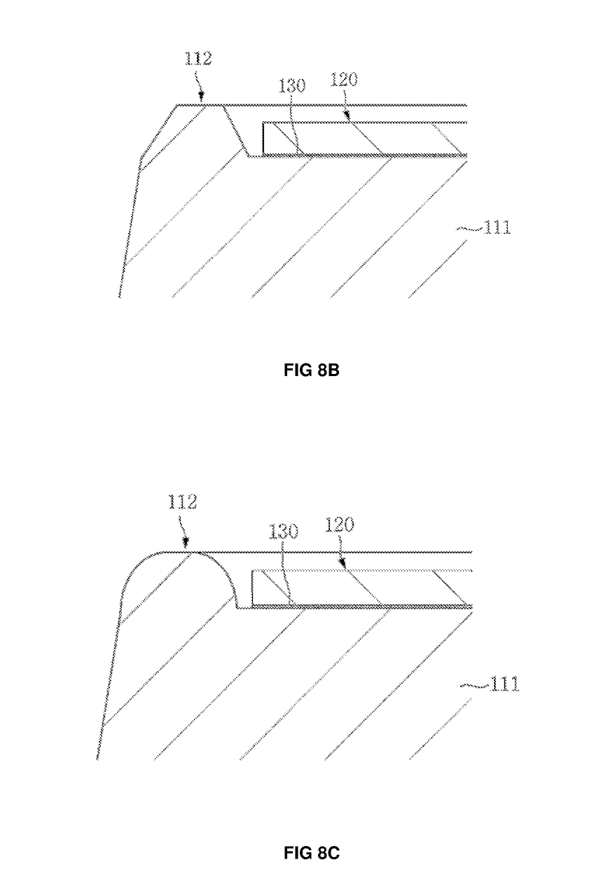

FIG. 8A to FIG. 8C illustrate respective cross-sectional views of variations of FIG. 4 where the edge shape of the ornament varies.

With a uniform thickness of the edge 112, at least one of both-side corners of the edge 112 may vary in a shape thereof as shown in FIG. 8A to FIG. 8C. To be specific, the shape of the corner may be rounded or non-right angled. In one example, as shown in FIG. 8A, a single corner (outer-side corner in the figure) may be non-right angled. In one example, as shown in FIG. 8B, both corners (outer-side and inner-side corners in the figure) may be non-right angled. In one example, as shown in FIG. 8C, both corners (outer-side and inner-side corners in the figure) may be rounded. The present disclosure is not limited to the figures in terms of the shape of the corner of the edge. Such a variation in the corner shape of the edge 112 in a combination with a shape of the metal sticker 120 may lead to various aesthetic feels, and, thus, various designs for the ornament 100.

Further, in addition to or instead of the above-described varying thickness of the edge 112, the edge 112 may vary in a height, that is, a vertical length thereof. In this connection, the metal sticker 120 may also vary in a height, that is, a vertical length thereof. A combination of such height variations of the sticker 120 and the edge 112 may lead to various aesthetic feels, and, thus, various designs for the ornament 100.

Furthermore, in addition to or instead of the above-described varying shapes of the edge 112 and the metal sticker 120, the frame 110, strictly, the edge 112 and the metal sticker 120 may vary in a color thereof. This may provide much freedom for a design presentation of the ornament 100. For example, the colors of the edge 112 and the metal sticker 120 may be selected to go well with a color of a leather of the leather product. Further, the colors of the edge 112 and the metal sticker 120 may be selected based on a consumer's preference.

The above description is not to be taken in a limiting sense, but is made merely for the purpose of describing the general principles of exemplary embodiments, and many additional embodiments of this disclosure are possible. It is understood that no limitation of the scope of the disclosure is thereby intended. The scope of the disclosure should be determined with reference to the Claims. Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

What is claimed is:

1. An ornament secured to a leather product, the ornament comprising:
a fame and a metal sticker attached to the frame,
wherein the frame comprises a body, an upwardly-protruding edge from a top face of the body and along an outer perimeter of the body, and a securing portion downwardly extending from a bottom face of the body and securing the body into a leather face portion of the leather product,
wherein the body is formed in a predetermined shape associated with the leather product, and the protruding edge extends along the shape,
wherein the metal sticker is formed in the shape,
wherein the protruding edge defines an attachment region on the top face of the body,
wherein the metal sticker is attached to the body in the attachment region thereof,
wherein the protruding edge allows an easy attachment of the sticker to the body, and prevents the sticker from a damage and/or a detachment due to an external force,
wherein the protruding edge has varying shapes to allow, in a combination with a shape of the metal sticker, a variety of designs for the ornament.

2. The ornament of claim 1, wherein the predetermined shape corresponds to a manufacture name character, logo, and/or a product name character of the leather product.

3. The ornament of claim 1, wherein the protruding edge varies in a horizontal and/or vertical length, and/or a shape of a corner thereof.

4. The ornament of claim 1, wherein the edge and/or the sticker has varying colors to allow a variety of designs for the ornament via a combination of the shape and color thereof.

5. The ornament of claim 2, wherein the edge and/or the sticker has varying colors to allow a variety of designs for the ornament via a combination of the shape and color thereof.

6. The ornament of claim 3, wherein the edge and/or the sticker has varying colors to allow a variety of designs for the ornament via a combination of the shape and color thereof.
